(19) United States
(12) Patent Application Publication
(10) Pub. No.: US 2014/0244428 A1
(43) Pub. Date: Aug. 28, 2014

(54) DYNAMIC PRESENTATION OF RECOMMENDED PRODUCTS TO USERS

(71) Applicant: LINKEDLN CORPORATION, Mountain View, CA (US)

(72) Inventors: Tong Yang, Mountain View, CA (US); Yining Wu, Sunnyvale, CA (US); Jacob M. Kessler, Palo Alto, CA (US); Timothy Lindvall, II, Mountain View, CA (US); Wendy Shi, Mountain View, CA (US); Venu Javarappa, San Jose, CA (US)

(73) Assignee: Linkedln Corporation, Mountain View, CA (US)

(21) Appl. No.: 13/781,590

(22) Filed: Feb. 28, 2013

(51) Int. Cl. G06Q 30/06

(52) U.S. Cl. CPC G06Q 30/0631
USPC 705/26.7

(57) ABSTRACT

The disclosed embodiments provide a system that facilitates interaction with a user. During operation, the system obtains a set of features associated with one or more products recommended for the user. Next, the system provides an editor for modifying the features and obtains one or more customizations to the features through the editor. Finally, the system displays the features and the customizations to the user without requiring modification to source code associated with displaying the features to the user.

### RELATED APPLICATION

The subject matter of this application is related to the subject matter in a co-pending non-provisional application by inventors Jacob M. Kessler, Tong Yang, Jinchun Xia, Bin Pan, Yining Wu, Wendy Shi and Venu Javarappa and filed on the same day as the instant application, entitled “Dynamic Ranking of Products for Presentation to Users,” having serial number TO BE ASSIGNED, and filing date TO BE ASSIGNED (Attorney Docket No. LI-P0144.LNK.US).

### BACKGROUND

1. Field

The disclosed embodiments relate to recommendation of products. More specifically, the disclosed embodiments relate to techniques for dynamically presenting recommended products to users.

2. Related Art

Consumers are often presented with a variety of choices for goods, services, and/or other products, which may interfere with the consumers' ability to identify and select suitable products for purchase and/or use. To facilitate such consumer decisions, providers of the products may recommend and/or filter the products based on the consumers' needs, preferences, and/or characteristics. For example, an online retailer may suggest products to a user based on the user's purchase history, user profile, method of accessing the online retailer, similarity to other users, and/or explicitly stated preferences.

However, changes to mechanisms for recommending and/or presenting the products to the users may involve significant time and/or overhead. For example, the deployment of a new recommendation engine for products provided by an online retailer may require changes to the software architecture and/or source code for the backend of the online retailer. Similarly, changes to the marketing and/or presentation of recommended products on the online retailer's website may be made by a product manager and implemented by an engineering team. In turn, a release cycle for the changes may take one to two weeks and require communication and/or collaboration between the product manager and engineering team. Moreover, miscommunication and/or other human errors may cause the implementation of the changes by the engineering team to differ from the product manager's expectations of the appearance of the changes.

Consequently, selection and use of products by users may be improved by streamlining changes to mechanisms for recommending and/or presenting the products to the users.

### SUMMARY

The disclosed embodiments provide a system that facilitates interaction with a user. During operation, the system obtains a set of features associated with one or more products recommended for the user. Next, the system provides an editor for modifying the features and obtains one or more customizations to the features through the editor. Finally, the system displays the features and the customizations to the user without requiring modification to source code associated with displaying the features to the user.

In some embodiments, obtaining the set of features associated with the one or more products recommended for the user involves:

(i) providing user data for the user to a ranking engine for a set of products;

(ii) obtaining, in response to the provided user data, a list of ranked products for the user from the ranking engine; and

(iii) obtaining the set of features based on the list.

In some embodiments, the user data includes at least one of a user type, a user context, and a user profile.

In some embodiments, providing the editor for modifying the features involves at least one of:

(i) displaying the features within a layout to be presented to the user;

(ii) enabling the one or more customizations to the features within the layout; and

(iii) enabling modification of the layout.

In some embodiments, enabling the one or more customizations to the features within the layout involves providing a set of options for each feature from the set of features, and enabling selection of one of the options for inclusion in the layout.

In some embodiments, enabling the one or more customizations to the features within the layout further involves enabling modification of the options.

In some embodiments, displaying the features and the customizations to the user without requiring modification to the source code associated with displaying the features to the user involves obtaining data comprising the options and the selection, and using the data to display the selection within the layout.

In some embodiments, the set of features includes at least one of a string, an image, and a media file.

### BRIEF DESCRIPTION OF THE FIGURES

FIG. 1 shows a schematic of a system in accordance with the disclosed embodiments.

FIG. 2 shows the use of a ranking engine to provide a list of ranked products for a user in accordance with the disclosed embodiments.

FIG. 3 shows the customization of a set of features for a product in accordance with the disclosed embodiments.

FIG. 4 shows an exemplary screenshot in accordance with the disclosed embodiments.

FIG. 5 shows a flowchart illustrating the processing of user data in accordance with the disclosed embodiments.

FIG. 6 shows a flowchart illustrating the process of facilitating interaction with a user in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

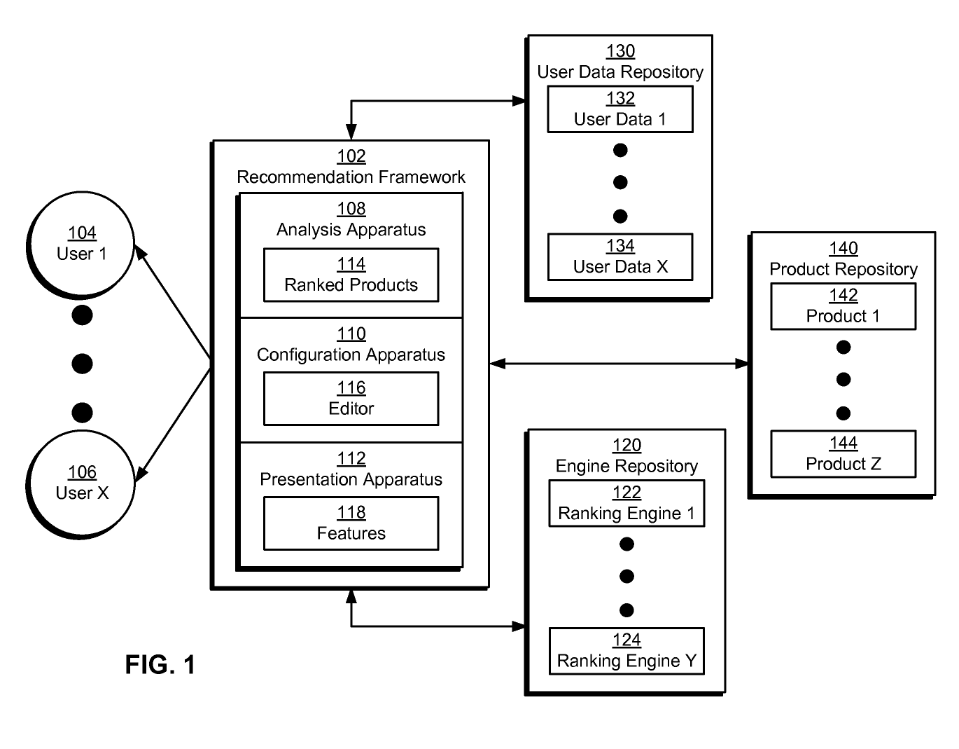

The disclosed embodiments provide a method and system for facilitating interaction with a user. More specifically, the disclosed embodiments provide a method and system for facilitating the recommendation of products to a user and/or the selection and use of recommended products by the user. As shown in FIG. 1, recommendations for a set of products (e.g., product 1 142, product z 144) in a product repository 140 may be made to a set of users (e.g., user 1 104, user x 106) by a recommendation framework 102. For example, recommendation framework 102 may be configured to recommend goods, services, and/or other products provided by a business, organization, shop, and/or online retailer to the users.

In one or more embodiments, recommendation framework 102 includes functionality to dynamically configure and/or update the recommendation and presentation of products to the users. Such dynamic configuration may be faster, more efficient, and/or more effective than conventional mechanisms for updating the recommendation and/or presentation of products to the users and facilitate selection, purchase, and/or use of the products by the users.

First, an analysis apparatus 108 in recommendation framework 102 may obtain user data (e.g., user data 1 132, user data x 134) for each user from a user data repository 130. The user data may include a user type, such as the user's role and/or main purpose in using one or more products associated with recommendation framework 102. For example, a professional networking website may include user types for job seekers, sales, businesses, and/or hiring managers. The user data may also include a user context related to access and/or use of recommendation framework 102 and/or the products by the user. For example, the user context may identify the method (e.g., email, web search, personal referral, type of electronic device, etc.) by which the user accesses the business, organization, shop, and/or online retailer providing the products and/or usage patterns of the user with the business, organization, shop, and/or online retailer. Finally, the user data may include a user profile for the user. For example, the user profile may include demographic information (e.g., age, location, gender, education level, income level, occupation, etc.) for the user, a set of groups to which the user belongs, the user's contacts and/or connections, and/or other data related to the user's behavior and/or characteristics.

Next, analysis apparatus 108 may select a ranking engine (e.g., ranking engine 1 122, ranking engine y 124) from an engine repository 120, provide the user data to the ranking engine, and obtain a list of ranked products 114 for the user from the ranking engine. In other words, analysis apparatus 108 may use the ranking engine to obtain a set of products recommended for the user based on user data for the user.

Each ranking engine in engine repository 120 may use a different technique to rank and/or recommend products from product repository 140. For example, the ranking engine may be implemented using a machine-learning technique such as a classifier, decision tree, neural network, Bayesian network, and/or support vector machine. Alternatively, the ranking engine may be implemented as an expert system and/or other rules-based recommendation system. Finally, the ranking engine may be a default ranking engine that returns the same list of ranked products 114 independently of the user data.

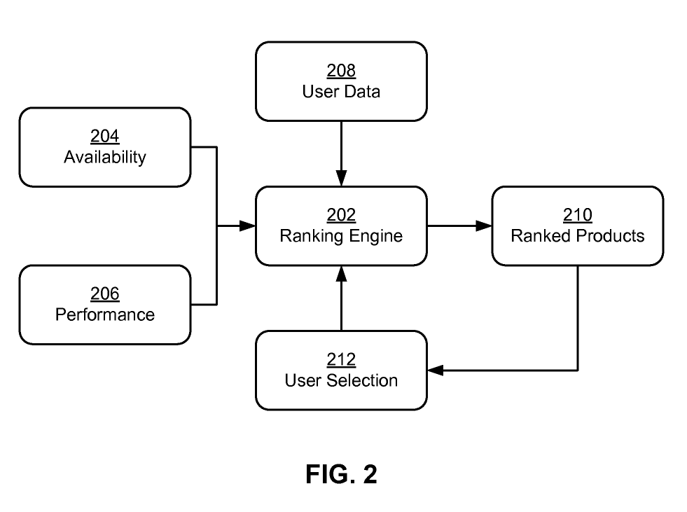

In one or more embodiments, analysis apparatus 108 selects the ranking engine for use in obtaining ranked products 114 based on the availability and/or performance of the ranking engine. For example, analysis apparatus 108 may obtain ranked products 114 from the ranking engine associated with the highest click-through-rate and/or revenue. On the other hand, if that ranking engine is unavailable (e.g., not executing), analysis apparatus 108 may obtain ranked products 114 from a different ranking engine and/or the default ranking engine. Selection and use of ranking engines in obtaining lists of ranked products for users is described in further detail below with respect to FIG. 2.

After the list of ranked products 114 is obtained by analysis apparatus 108, a presentation apparatus 112 in recommendation framework 102 may provide products in product repository 140 to the user based on the list to facilitate selection of one or more of the products by the user. For example, presentation apparatus 112 may display features 118 related to the top three ranked products 114 to the user within a user interface (e.g., web-based user interface, graphical user interface (GUI), etc.) and omit information related to lower ranked products in the list from the user interface.

If the user selects one or more products through presentation apparatus 112, analysis apparatus 108 may provide the user's selection of products to the ranking engine to update the behavior of the ranking engine. For example, analysis apparatus 108 may add the selection to a set of historical data that is used to train the ranking engine and/or update the ranking of products by the ranking engine. Furthermore, differences in the performance of the ranking engines may be tracked over time and/or compared to identify the strengths and weaknesses of each ranking engine. Ranking engines may also be added, updated, and/or phased out based on the comparisons to improve subsequent recommendation of products to users.

Recommendation framework 102 may further facilitate the user's selection and use of products by enabling dynamic changes to the presentation of features 118 associated with recommended products. More specifically, a configuration apparatus 110 in recommendation framework 102 may provide an editor 116 for modifying features 118 of the recommended products to be shown to the user and obtain one or more customizations to features 118 through the editor. For example, configuration apparatus 110 may provide editor 116 as a what-you-see-is-what-you-get (WYSIWYG) editor that allows a product manager for the products to directly update features 118 within a layout to be shown to the user.

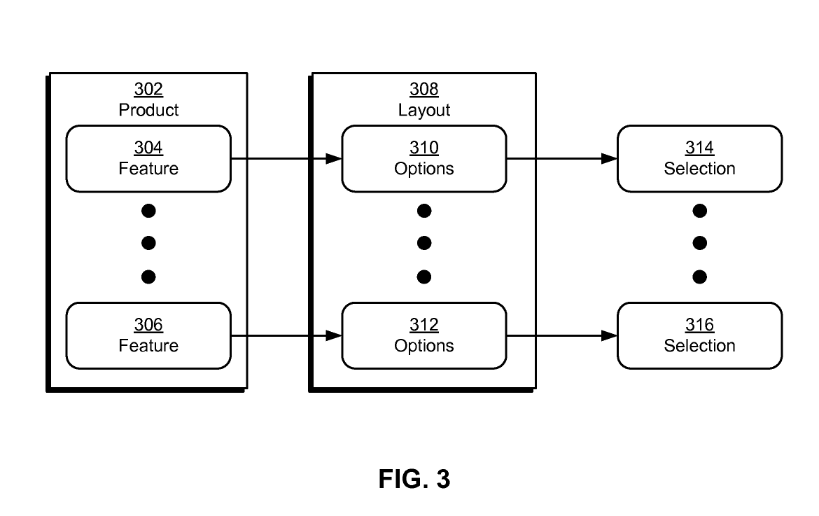

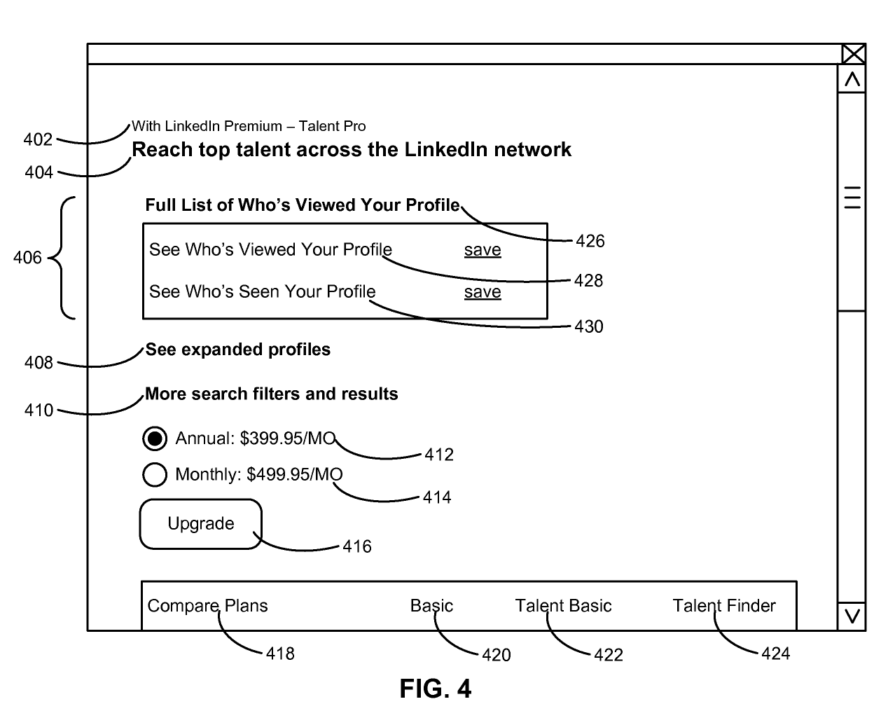

Presentation apparatus 112 may obtain the customizations and/or features 118 from configuration apparatus 110 and display the customizations and/or features 118 to the user without requiring modification to source code associated with displaying the features to the user. For example, presentation apparatus 112 may obtain the customizations and/or features 118 as data and render the data within a web page that is shown to the user. Customizing features of recommended products for presentation to users is discussed in further detail below with respect to FIGS. 3-4.

Consequently, recommendation framework 102 may increase the flexibility and/or efficiency with which product recommendations are made and/or presented to users. More specifically, the ability to dynamically select and/or update ranking engines for the products may improve the performance and/or availability of the ranking engines. Along the same lines, the decoupling of data for features 118 associated with the recommended products from mechanisms for displaying and/or presenting features 118 to the user may reduce overhead and/or errors associated with conventional deployment and/or implementation of changes to user-interface features 118.

Those skilled in the art will appreciate that the system of FIG. 1 may be implemented in a variety of ways. First, analysis apparatus 108, configuration apparatus 110, presentation apparatus 112, engine repository 120, user data repository 130, and product repository 140 may be provided by a single physical machine, multiple computer systems, one or more virtual machines, a grid, one or more databases, one or more filesystems, and/or a cloud computing system. Moreover, analysis apparatus 108, configuration apparatus 110, and presentation apparatus 112 may be implemented together and/or separately by one or more hardware and/or software components and/or layers.

Second, products, features, and/or user data associated with recommendation framework 102 may be defined and/or transmitted using a number of techniques. For example, recommendation framework 102 may obtain, store, and/or provide user data, ranked products 114, and/or features 118 as property lists, Extensible Markup language (XML) documents, JavaScript Object Notation (JSON) objects, and/or other types of structured data. The data may then be passed among the components of recommendation framework 102 through interfaces (e.g., application programming interfaces (APIs)) associated with the components.

FIG. 2 shows the use of a ranking engine 202 to provide a list of ranked products 210 for a user in accordance with the disclosed embodiments. As mentioned above, ranking engine 202 may be selected based on an availability 204 of ranking engine 202 and/or a performance 206 of ranking engine 202. For example, ranking engine 202 may be selected from a list of available (e.g., running, deployed, etc.) ranking engines, sorted by decreasing click-through rate and/or revenue.

Once ranking engine 202 is selected, user data 208 for the user is provided to ranking engine 202. User data 208 may include information that may be relevant to the user's preference for products associated with ranking engine 202. For example, user data 208 may include a user type, user context, and/or user profile for the user.

In response to user data 208, ranking engine 202 may generate a list of ranked products 210 for the user. For example, ranking engine 202 may apply a number of rules and/or statistical techniques to classify the user based on user data 208 and assign a score to each product according to the relevance, desirability, and/or applicability of the product to the user. Ranking engine 202 may then sort the products in decreasing order of score and provide a subset and/or complete list of the sorted products as ranked products 210.

Finally, a user selection 212 of one or more ranked products 210 may be provided to ranking engine 202 to update the behavior of ranking engine 202. For example, user selection 212 and/or other user selections of products recommended by ranking engine 202 may continually be added to a set of historical data associated with ranking engine 202. The historical data may then be used to train and/or update ranking engine 202 if ranking engine 202 is implemented using a machine-learning technique. Conversely, the historical data may be provided to an expert for manual update of rules in ranking engine 202 if ranking engine 202 is implemented as an expert system. Ranked products 210 and/or other historical data may also be used to update the behavior of ranking engines other than the selected ranking engine 202.

The performance of ranking engine 202 may also be tracked and used in subsequent selections of ranking engines for recommendation of products to users. For example, the performance of ranking engine 202 may be measured as a click-through rate, revenue, and/or other metric associated with the selection and/or purchase of products recommended by ranking engine 202. If ranking engine 202 performs better than other ranking engines, ranking engine 202 may be selected over the other ranking engines in providing lists of ranked products for users. However, if ranking engine 202 falls in performance and/or another ranking engine improves over time, the other ranking engine may be selected over ranking engine 202 in recommending products to users.

FIG. 3 shows the customization of a set of features 304-306 for a product 302 in accordance with the disclosed embodiments. The product may be selected for recommendation to a user by a ranking engine, such as ranking engine 202 of FIG. 2. To further facilitate selection and/or use of product 302 by the user, a set of features 304-306 associated with product 302 may be presented to the user. For example, features 304-306 displayed to the user within a user interface may include one or more strings, images, and/or media files that describe, depict, advertise, and/or represent product 302. Features 304-306 may also be personalized to the user. For example, features 304-306 may include the user's name, images of the user, and/or testimonials and/or reviews of product 302 by the user's contacts.

To enable modifications to features 304-306, option sets 310-312 for features 304-306 may be displayed within a layout 308 to be presented to the user. For example, a given feature may be associated with a set of three different options, and each option may be viewed at the feature's location within layout 308 to determine the best option for presenting the feature to the user. Moreover, the number of options in an option set may be limited to facilitate identification and selection of an appropriate option for the feature and reduce the complexity associated with using the editor.

On the other hand, option sets 310-312 and/or layout 308 may be modified to increase the configurability of the presentation of product 302 to the user. For example, option sets 310-312 may be shown within layout 308 by a WYSIWYG editor. A feature may be modified through the WYSIWYG editor by selecting one of the options for the feature and/or changing the string, image, and/or media file associated with the selected option. Moreover, layout 308 may be modified through the WYSIWYG editor by adding features to layout 308, removing features from layout 308, and/or rearranging the features within layout 308.

After modification to features 304-306 and/or layout 308 is complete, features 304-306 and/or customizations to features 304-306 may be displayed to the user by obtaining option sets 310-312 and selections 314-316 of specific options 310-312 as data and using the data to display selections 314-316 within layout 308. Because the data is decoupled from source code used to render features 304-306 within layout 308, changes to the data may not require modification to the source code, thus reducing overhead associated with deploying changes to product 302 and/or features 304-306.

FIG. 4 shows an exemplary screenshot in accordance with the disclosed embodiments. More specifically, FIG. 4 shows a screenshot of an editor (e.g., editor 116 of FIG. 1) for modifying a set of features 402-424 associated with one or more recommended products. As described above, the editor may be a WYSIWYG editor that shows features 402-424 within a layout to be presented to a user. Because features 402-404 are associated with product recommendations for a particular type and/or category of user, features 402-404 may be accessed and/or modified through the editor by providing information (e.g., user type, user context, user profile data) related to the type and/or category to the editor.

Features 402-424 may describe, define, and/or represent one or more products recommended to the user. For example, feature 402 (e.g., “With LinkedIn Premium—Talent Pro”) and feature 404 (e.g., “Reach top talent across the LinkedIn network”) may introduce and/or summarize the recommended product(s). Next, feature 406 (e.g., “Full List of Who's Viewed Your Profile”), feature 408 (e.g., “See expanded profiles”) and feature 410 (e.g., “More search filters and results”) may describe attributes and/or benefits of the recommended product(s). Feature 412 (e.g., “Annual: $399.95/MO”) and feature 414 (e.g., “Monthly: $499.95/MO”) may specify pricing options for the recommended product(s), and feature 416 (e.g., “Upgrade”) may represent a button that allows the user to select and/or purchase the recommended product(s). Feature 418 (e.g., “Compare Plans”) may begin a section of the layout that compares multiple recommended products, and feature 420 (e.g., “Basic”), feature 422 (e.g., “Talent Basic”), and feature 424 (e.g., “Talent Finder”) may provide names of the recommended products. Additional features (not shown) used to compare the recommended products may then be shown below features 418-424 within the layout.

Customizations to features 402-424 may be made through the editor. As shown in FIG. 4, feature 406 may include a set of options 426-430, including a default and/or selected option 426 (e.g., “Full List of Who's Viewed Your Profile”), a first non-selected option 428 (e.g., “See Who's Viewed Your Profile”), and a second non-selected option 430 (e.g., “See Who's Seen Your Profile”). To update feature 406, one of the options 426-430 may be selected, and one or more of options 426-430 may be modified. For example, the string associated with default option 426 may be replaced with a custom string by selecting option 428 over option 426 and editing the string associated with option 428. Other features 402-404 and 408-424 may be modified by selecting (e.g., clicking on) the area of the layout containing the features and accessing the options for the features.

The editor may also enable modification of the layout. For example, features 402-424 may be rearranged by dragging features 402-424 around within the layout. New features may also be added to the layout, and existing features 402-424 may be removed and/or deleted from the layout.

After updating of features 402-424 and/or the layout are complete, the modifications, features 402-424, and/or layout may be exported as data. The data may then be used to display the customizations and features 402-424 within the layout without requiring modification to source code associated with displaying the features to the user. For example, the layout, features 402-424, and/or customizations may be shown to all users that match the category associated with the recommended products immediately after the customizations are saved and/or committed by the editor.

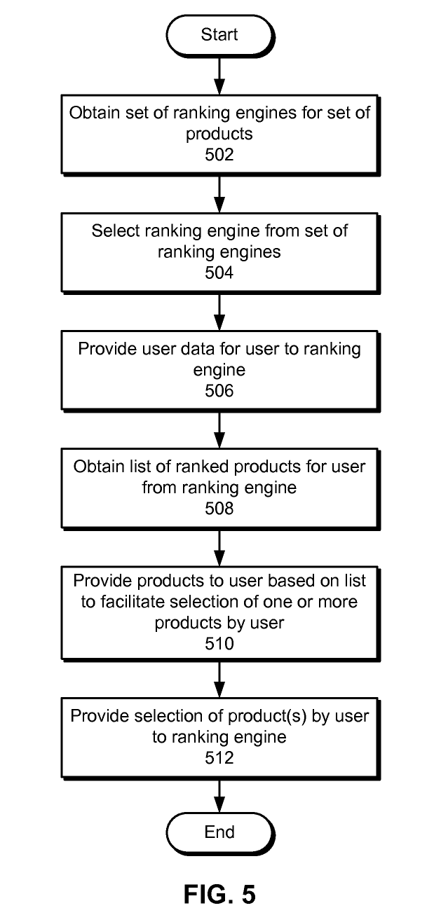

FIG. 5 shows a flowchart illustrating the processing of user data in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, a set of ranking engines for a set of products is obtained (operation 502). The ranking engines may be implemented using machine-learning techniques and/or as expert systems. The ranking engines may also include one or more default ranking engines that recommend products independently of user data and/or in the absence and/or unavailability of other ranking engines. Next, a ranking engine from the set of ranking engines is selected (operation 504). For example, the ranking engine may be selected based on the availability and/or performance of the ranking engine. In addition, selection of the ranking engine may occur periodically and/or dynamically (e.g., upon request) to enable the recommendation of products to users using the most up-to-date and/or highest performing ranking engine.

After the ranking engine is selected, user data for a user is provided to the selected ranking engine (operation 506). The user data may include a user type, a user context, a user profile, and/or other information that may be used by the ranking engine to classify and/or categorize the user. A list of ranked products for the user may then be obtained from the ranking engine (operation 508) in response to the provided user data. For example, the list may include a predefined number of the highest-ranked products for the user, or the list may include a complete set of products associated with the ranking engine, sorted in decreasing order of relevance, applicability, and/or desirability for the user.

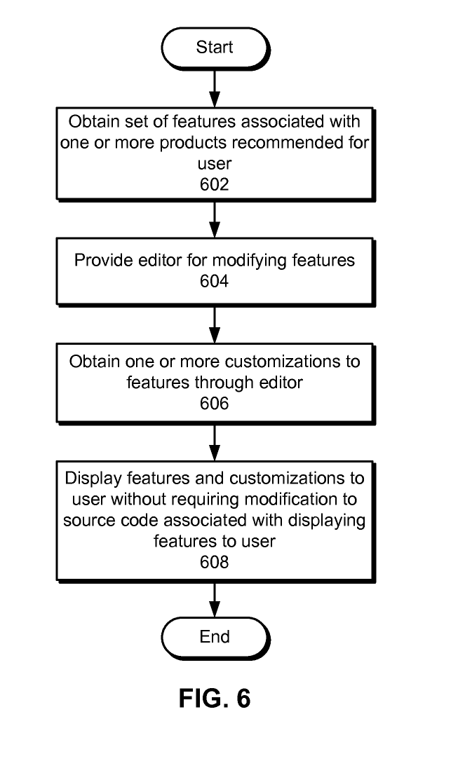

The products are provided to the user based on the list to facilitate selection of one or more of the products by the user (operation 510). For example, a set of features associated with the product(s) may be obtained and displayed to the user based on the list and/or user data. Customizations to the features may also be obtained prior to displaying the features to the user and included in the displayed features without requiring modification to source code associated with displaying the features to the user, as discussed in further detail below with respect to FIG. 6.

Finally, a selection of the product(s) by the user is provided to the ranking engine (operation 512) to update the behavior of the ranking engine. For example, the user's selection may be used to train the ranking engine and/or modify rules used by the ranking engine to recommend products to users.

FIG. 6 shows a flowchart illustrating the process of facilitating interaction with a user in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the technique.

First, a set of features associated with one or more products recommended for a user is obtained (operation 602). The features may include strings, images, and/or media files that describe, represent, advertise, and/or define the products. The features may also be customized to the user. For example, the features may be tailored to the user's role and/or interests, identify the user by name, and/or describe use of and/or experiences with the recommended products by other users related to the user.

Next, an editor for modifying the features is provided (operation 604), and one or more customizations to the features are obtained through the editor (operation 606). The editor may be a WYSIWYG editor that displays the features within a layout to be presented to the user and enables the customizations to the features within the layout and/or modification of the layout by a product manager and/or other person associated with recommending and/or selling the product(s). For example, the editor may provide a set of options for each feature in the layout and enable modification of the options and/or selection of one of the options for inclusion in the layout. The editor may also allow features to be added to the layout, removed from the layout, and/or rearranged within the layout.

Finally, the features and customizations are displayed to the user without requiring modification to source code associated with displaying the features to the user (operation 608). Continuing with the above example, data containing the options and the selection may be obtained for each feature and used to display the selection within the layout. Because the data is decoupled from source code used to render the data within the layout, the amount of overhead and/or human error associated with implementing changes to the features may be reduced.

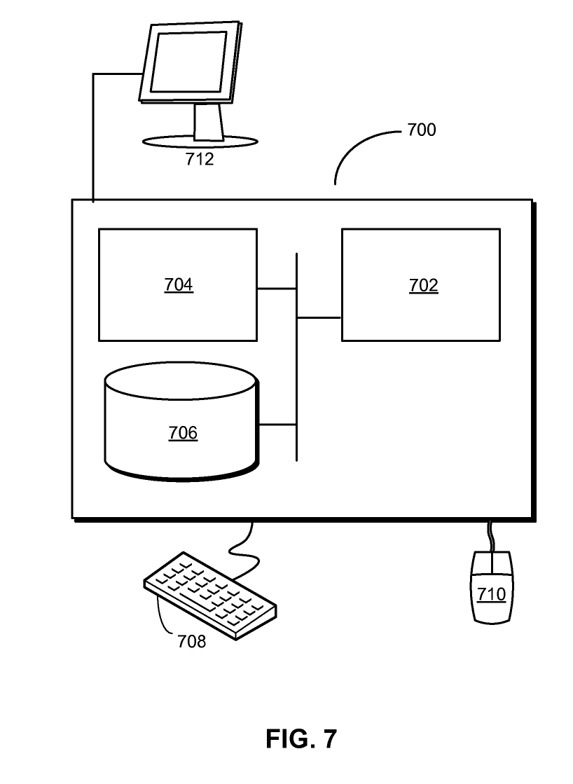

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for facilitating interaction with a user. The system may include an analysis apparatus that obtains a set of ranking engines for a set of products and selects a ranking engine from the set of ranking engines. Next, the analysis apparatus may provide the user data for the user to the ranking engine and obtain, in response to the provided user data, a list of ranked products for the user from the ranking engine. The system may also include a presentation apparatus that provides the products to the user based on the list to facilitate selection of one or more of the products by the user.

The system may further include a configuration apparatus that obtains a set of features associated with one or more products recommended for the user, such as the ranked products. The configuration apparatus may also provide an editor for modifying the features and obtain one or more customizations to the features through the editor. The presentation apparatus may then display the features and customizations to the user without requiring modification to source code associated with displaying the features to the user.

In addition, one or more components of computer system 700 may be remotely located and connected to the other components over a network. Portions of the present embodiments (e.g., analysis apparatus, configuration apparatus, presentation apparatus, etc.) may also be located on different nodes of a distributed system that implements the embodiments. For example, the present embodiments may be implemented using a cloud computing system that dynamically generates and/or presents recommendations of products to a set of remote users based on user data for the users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating interaction with a user, comprising:
obtaining a set of features associated with one or more products recommended for the user;
providing an editor for modifying the features;
obtaining one or more customizations to the features through the editor; and
displaying the features and the customizations to the user without requiring modification to source code associated with displaying the features to the user.

2. The computer-implemented method of claim 1, wherein obtaining the set of features associated with the one or more products recommended for the user comprises:
providing user data for the user to a ranking engine for a set of products;
obtaining, in response to the provided user data, a list of ranked products for the user from the ranking engine; and
obtaining the set of features based on the list.

3. The computer-implemented method of claim 2, wherein the user data comprises at least one of:
a user type;
a user context; and
a user profile.

4. The computer-implemented method of claim 1, wherein providing the editor for modifying the features comprises at least one of:
displaying the features within a layout to be presented to the user;
enabling the one or more customizations to the features within the layout; and
enabling modification of the layout.

5. The computer-implemented method of claim 4, wherein enabling the one or more customizations to the features within the layout comprises:
providing a set of options for each feature from the set of features; and
enabling selection of one of the options for inclusion in the layout.

6. The computer-implemented method of claim 5, wherein enabling the one or more customizations to the features within the layout further comprises:
enabling modification of the options.

7. The computer-implemented method of claim 5, wherein displaying the features and the customizations to the user without requiring modification to the source code associated with displaying the features to the user comprises:
obtaining data comprising the options and the selection; and
using the data to display the selection within the layout.

8. The computer-implemented method of claim 1, wherein the set of features comprises at least one of:
a string;
an image; and
a media file.

9. A system for facilitating interaction with a user, comprising:
a configuration apparatus configured to:
obtain a set of features associated with one or more products recommended for the user;
provide an editor for modifying the features; and
obtain one or more customizations to the features through the editor; and
a presentation apparatus configured to display the features and the customizations to the user without requiring modification to source code associated with displaying the features to the user.

10. The system of claim 9, wherein obtaining the set of features associated with the one or more products recommended for the user comprises:
providing user data for the user to a ranking engine for a set of products;
obtaining, in response to the provided user data, a list of ranked products for the user from the ranking engine; and
obtaining the set of features based on the list.

11. The system of claim 9, wherein providing the editor for customizing the features comprises at least one of:
displaying the features within a layout to be presented to the user;
enabling the one or more customizations to the features within the layout; and
enabling modification of the layout.

12. The system of claim 11, wherein enabling the one or more customizations to the features within the layout comprises:
providing a set of options for each feature from the set of features; and
enabling selection of one of the options for inclusion in the layout.

13. The system of claim 12, wherein enabling the one or more customizations to the features within the layout further comprises:
enabling modification of the options.

14. The system of claim 12, wherein displaying the features and the customizations to the user without requiring modification to the source code associated with displaying the features to the user comprises:
obtaining data comprising the options and the selection; and
using the data to display the selection within the layout.

15. A computer-readable storage medium storing instructions that when executed by a computer cause the computer to perform a method for facilitating interaction with a user, the method comprising:
obtaining a set of features associated with one or more products recommended for the user;
providing a editor for modifying the features;
obtaining one or more customizations to the features through the editor; and
displaying the features and the customizations to the user without requiring modification to source code associated with displaying the features to the user.

16. The computer-readable storage medium of claim 15, wherein obtaining the set of features associated with the one or more products recommended for the user comprises:
providing user data for the user to a ranking engine for a set of products;
obtaining, in response to the provided user data, a list of ranked products for the user from the ranking engine; and
obtaining the set of features based on the list.

17. The computer-readable storage medium of claim 15, wherein providing the editor for customizing the features comprises at least one of:
displaying the features within a layout to be presented to the user;
enabling the one or more customizations to the features within the layout; and
enabling modification of the layout.

18. The computer-readable storage medium of claim 17, wherein enabling the one or more customizations to the features within the layout comprises:
providing a set of options for each feature from the set of features; and
enabling selection of one of the options for inclusion in the layout.

19. The computer-readable storage medium of claim 18, wherein enabling the one or more customizations to the features within the layout further comprises:
enabling modification of the options.

20. The computer-readable storage medium of claim 18, wherein displaying the features and the customizations to the user without requiring modification to the source code associated with displaying the features to the user comprises:
obtaining data comprising the options and the selection; and
using the data to display the selection within the layout.
